(19) United States
(12) Patent Application Publication
(10) Pub. No.: US 2022/0253512 A1
(43) Pub. Date: Aug. 11, 2022

(54) AUTHENTICATING AND VERIFYING USERS WITH UNIQUE IDENTIFICATION NUMBERS AND FINGER VEIN PATTERNS

(71) Applicant: LyfBio LLC, Gaithersburg, MD (US)

(72) Inventor: Sulaiman O. Ismail, Potomac, MD (US)

(21) Appl. No.: 17/183,532

(22) Filed: Feb. 24, 2021

Related U.S. Application Data
(60) Provisional application No. 63/146,764, filed on Feb. 8, 2021.

(51) Int. Cl. G06F 21/32; H04L 29/06; G06Q 20/40; G06K 9/00

(52) U.S. Cl. CPC G06F 21/32; H04L 63/0838; H04L 2463/082; G06Q 20/40145; G06K 9/00087; H04L 63/0861

(57) ABSTRACT

Techniques for executing authenticated and verified transactions using a finger vein pattern in combination with a Unique Identification Number (UIN) is disclosed. The techniques may be used to process one or more payment transactions between a registered customer and a registered merchant. The UIN and the finger vein pattern of the customer authorize payment to a merchant once a match is authenticated and verified based on the UIN and finger vein pattern.

### PRIORITY CLAIM

This application claims priority to U.S. Provisional Application No. 63/146,764, filed Feb. 8, 2021. The entirety of this application is incorporated herein by reference.

### FIELD OF INVENTION

The present invention relates to the field of identification and authentication of a user and, in particular, identifying and authenticating a user with a unique identification number and finger vein pattern.

### BACKGROUND

Face-to-face transactions between merchants and customers are generally based on payment by card (e.g., credit or debit card(s)) for the payment of product(s) or service(s)). This usually requires the customer to insert or swipe a card into or through a reader included in or connected to a point-of-sale device. Alternatively, a user may be able to tap a card against a reader/point-of-sale device or transfer card data to a point-of-sale device via a contactless payment method, such as a phone app. The point-of-sale device then processes payments between the Merchant(s) and the Customer(s).

For verification and security clearance, merchant(s) sometimes request the customer(s) to present a proof of identification (e.g., Government issued ID like Drivers' license or International Passport) and payment is then processed. However, proof of identification is rarely required/implemented and, card fraud is relatively widespread. In response to card fraud, customers dispute transactions, which, in turn, cost banks and insurance companies, if not merchants themselves, billions of dollars in losses on an annual basis.

In view of at least the aforementioned issues, an efficient system and method for verifying and authenticating a user's identity is desirable.

### SUMMARY

The present invention relates to a system and method to authenticate and verify a user. In accordance with at least one embodiment of the present invention, the method includes receiving, at a processor, a unique identification number (UIN) and finger vein data corresponding to a user; comparing, via the processor, the received UIN to a database comprising stored user profiles, the user profiles comprising stored UINs with corresponding stored finger vein data; identifying, via the processor, one or more user profiles based on the UIN; comparing, via the processor, the received finger vein data to the stored finger vein data of the determined one or more user profiles; and authenticating the user based on the comparing.

### BRIEF DESCRIPTION OF THE DRAWINGS

To complete the description and in order to provide for a better understanding of the present invention, a set of drawings is provided. The drawings form an integral part of the description and illustrate an embodiment of the present invention, which should not be interpreted as restricting the scope of the invention, but just as an example of how the invention can be carried out. The drawings comprise the following figures:

FIG. 1 is a diagram depicting an authentication system for a one-time online account registration process, according to an exemplary embodiment.

FIG. 2 is a diagram depicting a finger vein reading system and one-time finger vein pattern registration process, according to an exemplary embodiment.

FIG. 3 is a diagram depicting an authentication process for authenticating a user, according to an exemplary embodiment.

FIG. 4 is a diagram depicting a one-time merchant registration process, according to an exemplary embodiment.

FIG. 5A is a flow chart depicting a registration process occurring at a user's device, according to an exemplary embodiment.

FIG. 5B is a flow chart depicting a registration process occurring at a merchant's device, according to an exemplary embodiment.

FIG. 5C is a flow chart depicting a registration process occurring at a server, according to an exemplary embodiment.

FIG. 6A is a flow chart depicting a merchant registration process occurring at a merchant device, according to an exemplary embodiment.

FIG. 6B is a flow chart depicting a merchant registration process occurring at a server, according to an exemplary embodiment.

FIG. 7A is a flow chart depicting a transaction process occurring at a merchant device, according to an exemplary embodiment.

FIG. 7B is a flow chart depicting an authenticating a transaction process occurring at a server, according to an exemplary embodiment.

FIG. 8 is a block diagram of a computing device, according to an exemplary embodiment.

### DETAILED DESCRIPTION

The following description is not to be taken in a limiting sense but is given solely for the purpose of describing the broad principles of the invention. Embodiments of the invention will be described by way of example, with reference to the above-mentioned drawings showing elements and results according to the present invention.

The techniques presented herein utilize finger vein technology and unique identification number (UIN) assignments to authenticate and verify a user/customer's identity during an electronic payment transaction. Thus, the systems and methods presented herein help secure transactions between customer(s) and merchant(s). These secure transactions can prevent fraud and can save financial institutions billions of dollars.

Put another way, the techniques presented herein associate two unique pieces of information with a user (the UIN and the user's finger vein pattern) to create a two-factor authentication during electronic payments. However, to ensure that the two-factor authentication does not cause undesirable processing delays at the point-of-sale (POS), the techniques streamline the backend processing of both pieces of information. That is, the UINs are assigned and/or distributed to users in a manner that improves processing of biometric information. Thus, secure and authenticated payments may be processed in nearly the same amount of time as traditional card payments (e.g., via chip insertion, swiping, or tapping) and avoid disrupting the flow of business at a POS, all while providing identity authentication and verification.

More specifically, the techniques presented herein may utilize the UIN to limit the number of stored vein patterns processed (e.g., analyzed) during a given transaction. By comparison, typically, the amount of time to carry out a comparison is highly impacted by, if not governed by, the amount of stored data to which received images or image data must be compared. For example, if a received image must be matched to one imaged stored within a collection of hundreds or thousands (if not more) stored images to authenticate a user, conventional techniques may compare the received image to each image in the collection until a match is found. This uses considerable processing power, occupying a substantial amount of a processor's computing resources. Moreover, as the size of the collection grows, the processing time will grow in-step. Consequently, for large and/or growing collections, authenticating a user based on a received image may take a considerable amount of time and computing resources. Advantageously, by using a UIN in combination with a vein pattern, this processing improvement may be realized naturally and/or automatically.

The authentication and verification method and system is described with use of authorizing payments for sales or services; however, embodiments are not limited thereto. The authentication and verification method and system may be applied to any situation where authentication and verification of a user's identity is desirable. For example, the system and method described herein may be applied to security systems for authorizing a user for access to a computer terminal, a network, a cloud-based database, a cloud-based document, a website, a building, a room, a closet, a storage device, online payments, Automatic Teller Machines (ATMs), bank transactions (in person and/or online), etc.

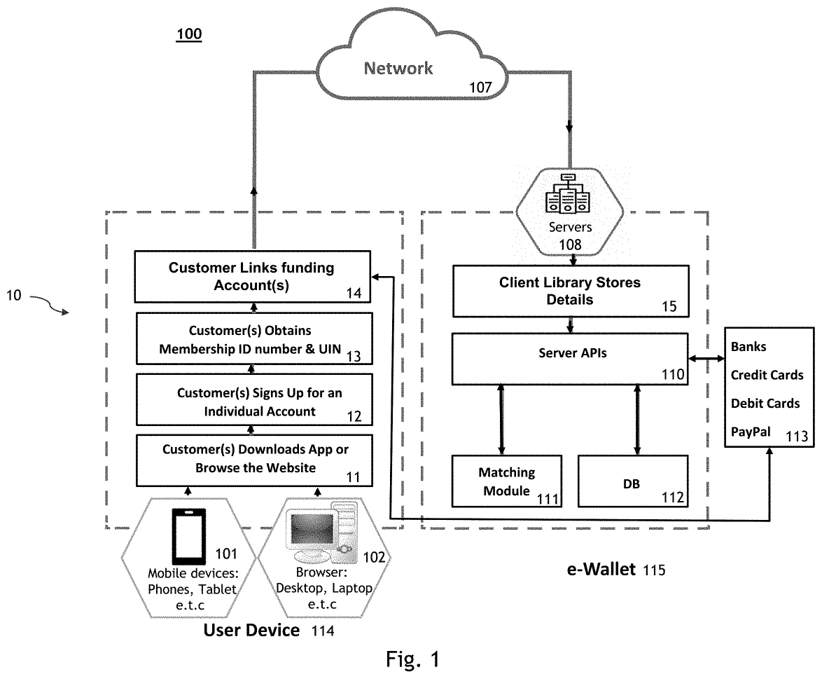

Now referring to FIG. 1 for a description of an authentication system 100 and a one-time online account registration process 10 expected of the customer when intending to use the authentication system 100 for the purpose of paying for any sales or services. The authentication system 100 includes a user device 114 (e.g., a mobile device 101 and/or computer 102 having a graphical user interface with a display) that can connect to one or more servers 108 over a network 107. The one or more servers 108 include a server application programming interface (API) 110 for interfacing with third party service providers 113 (e.g., banks, credit card companies, PayPal, etc.), a matching module 111, and a database 112. The one or more servers 108 support an e-wallet 115 for a user/customer to access during a transaction. For example, the registered user account may operate as an e-wallet 115.

The one-time account registration process 10 can be completed as an online registration with the aid of a downloadable App on the mobile device 101 or the browser of a computer, desktop, or laptop 102. The registration process includes downloading the App or accessing the website via a mobile device 101 or computer 102 in operation 11, requesting an account in operation 12, receiving a membership identification (ID) number and unique identification number (UIN) in operation 13, and linking funding accounts in operation 14. The one or more servers 108 receive the account information from the user 114 and store it in the database 112 to complete the registration process in operation 15.

More specifically, in operation 12, the user requests an account via the App or web browser accessed in operation 11. For example, the App or web browser causes the user device 114 (e.g., mobile device 101 and/or computer 102) to communicate with the one or more servers 108 via the network 107, and request initiation of an account registration with user's data (e.g., user's name, date of birth, address, phone number, etc.). When the techniques presented herein are utilized for financial transactions, certain data fields, such as name, date of birth, address, etc., may be required. The user may input the data via a graphical user interface of the user device 114.

In operation 13, the user obtains a membership ID number and UIN. In some instances, the membership ID and UIN are generated by the one or more servers 108 and are associated with the received user data. Then, the membership ID number and UIN are transmitted from the one or more servers 108 to the user device 114 and are displayed to the user/customer. Alternatively, the user may select their membership and/or UIN. The selection/generation of the UIN is described in further detail below; however, regardless of how the UIN is obtained, in some implementations, the one or more servers 108 may further transmit instructions to the user device 114 to request that the user links the account with a third-party service provider 113.

More specifically, at operation 13, a customer/user can obtain a UIN by being assigned a UIN from the one or more servers 108 or by selecting their own UIN via the customer device 114. In some implementations, the user may select one UIN from a group of UINs generated by the one or more servers 108. Alternatively, the user may create their own UIN to be approved and assigned by the one or more servers 108. When UINs are assigned, and/or approved, the UINs are assigned to dynamically balance the number of users associated with any particular UIN. This creates a natural filtering or hierarchal system, which enhances the speed at which transactions can be processed with finger vein pattern data. For example, UINs may be assigned based on user/customer phone numbers (e.g., the last four, five, six, or seven digits of a customer's phone number may be their UIN), which may naturally spread UIN amongst unique combinations. Regardless of how dynamic balancing is achieved, when a user completes a transaction with their UIN and scan of their finger vein pattern, the backend processing will only need to match a scanned finger vein pattern against a small portion of finger vein patterns registered with the system.

Additionally or alternatively, UINs may be associated with thresholds (fixed or dynamic) to ensure that particular UINs are associated with a limited number of UINs. Dynamic thresholds, if used, may vary based on the number of UINs in the system, the number of users in the system, the number of characters in the UIN, or any combination thereof. For example, in one embodiment, as many as 1000 registrations may be associated with each six-digit UIN. The UINs may be all numbers, alphabetic characters, or a combination thereof.

In operation 14, the user links one or more accounts from one or more third party service providers 113 to the account. The service providers 113 may include one or more of a bank, a credit card company, PayPal (or another online payment system), and/or other financial institution. For example, the user may enter third party account information and/or login credentials for the one or more third party service provider 113 into the user device 114, which may transmit the information to the one or more servers 108.

In operation 15, the one or more servers 108 store the user's data. The one or more servers 108 receive the user's data and third-party account information, and generate a user profile comprising the user's data, membership ID number, UIN, and third-party service provider account information. The user profile is stored in the database 112 and indexed by the corresponding membership ID number and/or UIN. Once the user profile is stored in the database 112, the account registration process 10 is complete.

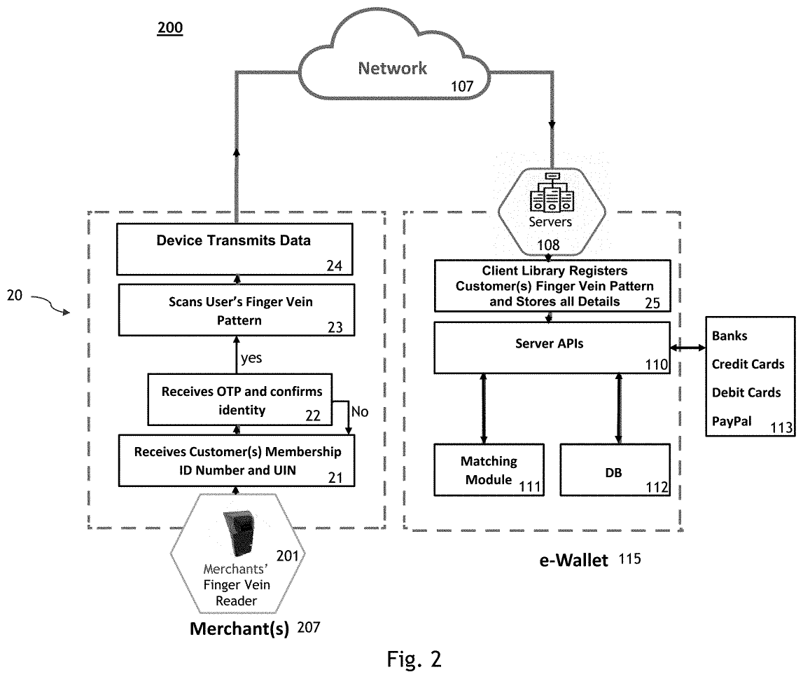

FIG. 2 illustrates a finger vein reading system 200 and a one-time finger vein pattern registration process 20 for registering any one finger of the customer with their stored profile to be used for the verification and/or authentication of payment at a Point-of-Sale (POS). The customer need only register one finger, but can register any number of fingers (e.g., up to ten) and the finger vein pattern of each registered finger will be associated with the user's account. Regardless, the user/customer must interact with a finger vein pattern reader 201 to complete this registration.

In the depicted embodiment, the finger vein registration system 200 includes a merchant device 207 (e.g., the finger vein reader 201, a mobile device, and/or a computer), the network 107, and the one or more servers 108. However, finger vein registration system 200 need not always include a merchant device 207. That said, the finger vein pattern reader 201 includes a sensor for detecting a finger vein pattern, and a processor. In some implementations, the vein pattern reader 201 may be configured to communicate with the one or more servers 108 over the network 107. Additionally, or alternatively, the vein pattern reader 201 may communicate with a computer (e.g., a mobile device 101, a computer 102) which in turn communicates with the one or more servers 108 over the network 107.

The finger vein pattern registration process 20 includes receiving a user's membership ID number and UIN at the finger vein pattern reader 201 in operation 21, confirming a user's identity with a one-time password (OTP) in operation 22, scanning one or more finger vein patterns of the user in response to confirming the user's identity in operation 23, and transmitting the membership ID number, the UIN, and the scanned finger vein pattern to the one or more servers 108. In response to receiving the one or more finger vein patterns, membership ID number, and UIN, the one or more servers 108 store the one or more finger vein patterns with the profile associated with the membership ID number and UIN in operation 25. Once the profile is updated with the one or more finger vein pattern and stored in the database, the finger vein registration process 20 is completed.

In operation 21, the finger vein reader 201 initiates the process 20 by prompting the user/customer for the user's membership ID number and UIN. The finger vein reader 201 receives from the user the membership ID number and UIN, then transmits them to the one or more servers 108. In response, the one or more servers 108 generates a one-time password (OTP) corresponding to the membership ID number and UIN, and transmits the OTP to the user device 114 via an email, a text message, or another secure message (e.g., a push notification pushed by an app installed on the user device 114). Additionally or alternatively, the one or more servers 108 may transmit the OTP to the finger vein reader 201 and/or merchant device 207.

In operation 22, the user's identity is confirmed with the OTP. In the depicted embodiment, the finger vein reader 201 receives an input from the user and compares the user's input with the OTP received from the one or more servers 108. For example, the user can enter the OTP received on the user device 114 one the graphical user interface of the finger vein reader 201. The finger vein reader 201 verifies, or confirms, the user's identity if it determines that the OTP entered by the user matches the OTP received from the one or more servers 108, and the finger vein registration process 20 continues to operation 23. If the finger vein reader 201 determines that the user's input and the OTP do not match, the finger vein reader 201 prompts the user to try again. The user is given a number of tries before the system 200 locks the user out of her profile, or the finger vein registration process 20 starts over at operation 21. However, again, the depicted embodiment is merely an example and in at least some implementations, the finger vein reader 201 can confirm an identity based on the OTP by communicating with the one or more servers 108 or any other remote computing resources (which may analyze the OTP and confirm the user's identity).

In operation 23, the finger vein reader 201 scans one or more of the user's fingers for one or more finger vein patterns that are unique to the user. For example, in response to verifying the user's identity, the finger vein reader 201 can prompt the user to place a finger to be scanned over the sensor of the finger vein reader 201. Upon detecting the user's finger is in place, the finger vein reader 201 activates the sensor and scans the user's finger vein pattern. In some implementations, operation 23 may be repeated for each finger the user would like to scan prior to any subsequent operations. Alternatively, some implementations may process one finger scan at a time and subsequent finger scans may be recorded by repeating finger vein pattern registration process 20 in its entirety. Either way, in some implementations, the user may not scan just her own finger, but also the finger of another person whom the user wants to have authorized access to the user's account (e.g., a family member). The finger vein reader 201 may further notify the user of success or failure to scan a finger vein pattern, and prompt the user to rescan the desired finger if the scan failed. After the finger vein reader 201 scans the desired one or more fingers, the process 20 continues to operation 24.

In operation 24, the finger vein reader 201 transmits finger vein data (e.g., one or more scanned finger vein patterns), the membership ID number, and the UIN to the one or more servers 108. In some implementations, the finger vein reader 201 may further transmit the OTP received from the user to the one or more servers 108 to confirm the user's identity.

In operation 25, the one or more servers 108 receive and store the received one or more finger vein patterns in the database 112. For example, the matching module 111 may compare the received Membership ID number, and received UIN with a stored membership ID number and stored UIN associated the user's profile. In some implementations, matching module may further compare the received OTP with a stored OTP associated with the user's profile to verify the user. The database 112 stores the finger vein data comprising one or more received finger vein patterns in the user's profile corresponding to the matched membership ID and UIN. Upon storing the one or more received finger vein patterns in the user's profile, the finger vein pattern registration process 20 is complete. Alternatively, if the received OTP, received Membership ID number, and/or received UIN do not match the stored OTP, the stored membership ID number and/or the stored UIN associated with the user, the one or more servers 108 rejects the received finger vein data and transmits an error notice to the finger vein reader 201. The finger vein registration process may start over at operation 21 or may be terminated.

Still referring to FIG. 2, as mentioned, the finger vein reader device 201 shown in FIG. 2 is merely an example. In some implementations, a processor (e.g., mobile device or computer) may be communicatively coupled to the finger vein reader 201 to relay data between the finger vein reader 201 and the one or more servers 108. In some instances, user registration with the system (e.g., per FIG. 2) could trigger shipment of a finger vein reader to the customer for temporary use (e.g., sent with a return label). Alternatively, the registering customer could use the finger vein reader at a participating merchant, or any other available device capable of scanning finger veins and communicating the captured data to another device (e.g., via BLUETOOTH, USB, Wifi, NFC) and/or the Internet. Regardless, once a device connected to the system presented herein receives finger vein data, the device can execute instructions stored in computer readable memory to complete a user registration (e.g., to associate the finger vein pattern with the user and a UIN of the user).

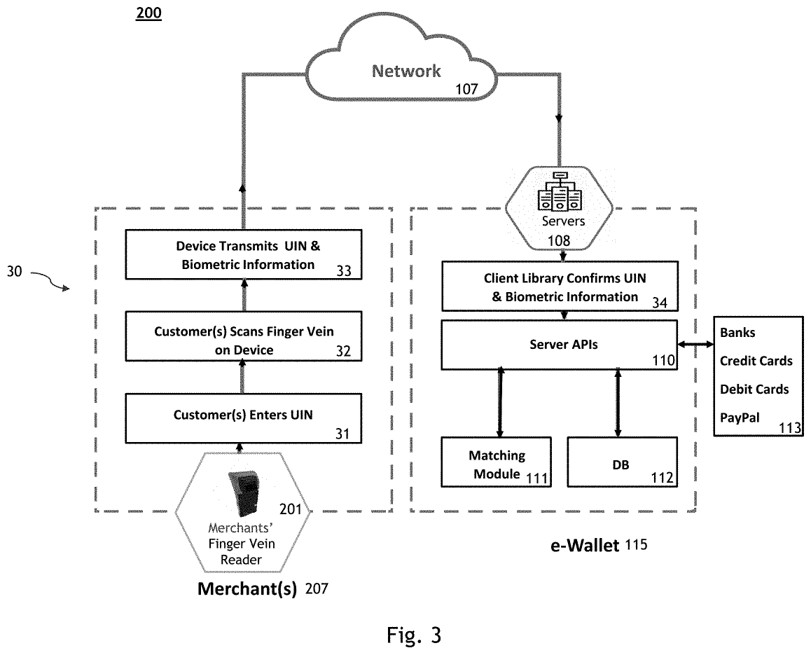

FIG. 3 illustrates an authentication process 30 for authenticating a user with the user's UIN and scanning a user's finger with the finger vein reading system 200. The authentication process 30 verifies and authenticates the user's details in order to authorize a user. For example, the authentication process 30 may include authorization of payment for transactions between an authenticated customer and a merchant while at the merchant's location to pay for any goods and services. In some implementations, the authentication process 30 may include authorizing the user to access a restricted area, building, terminal, computer, website, complete online payment and banking transactions (e.g., via ATMs or over the counter transactions), etc.

The authentication process 30 includes receiving a customer UIN in operation 31, scanning a finger vein pattern in operation 32, and transmitting the UIN and scanned finger vein pattern to the one or more servers 108 in operation 33. The one or more servers 108 compare the UIN and finger vein pattern to stored profiles in the database 112 to authenticate the customer and authorize a transaction in operation 34.

In operation 31, the finger vein reader 201 receives a UIN of a user to be authenticated. For example, the user can enter her previously assigned UIN at the finger vein reader 201. As mentioned, the UIN is previously assigned to the user during the online registration process 10 (discussed above with reference to FIG. 1). Once the UIN is entered, the finger vein reader 201 prompts the user to place her finger to be scanned on the reader's sensor, at operation 32. Alternatively, the UIN could be entered after a finger is scanned or simultaneously (e.g., if a merchant enters a UIN received from the customer (e.g., verbally) while the customer scans their finger). That is, operations 31 and 32 need not be performed in the depicted order.

Notably, although operation 31 indicates that a user enters their UIN, the user could also tell the merchant their UID (e.g., verbally) who could then input the UIN on their behalf. Alternatively, a user device could transmit the UID to a merchant device (e.g., in response to user verification at the user device, such as via fingerprint verification, face scanning verification, code verification, etc.). In some implementations, the authentication process 30 may be initiated by a transaction between a merchant and a customer. For example, the user may be the customer attempting to purchase goods or services from the merchant. The merchant may initiate the authentication process 30 by entering the transaction in a POS device communicatively coupled to the finger vein reader 201. In some implementations, the user may scan her finger with the finger vein reader 201 to initiate the authentication process 30, and then enter her UIN.

In operation 33, the finger vein reader 201 transmits the scanned finger vein pattern and the UIN to the one or more servers 108 for authentication. For example, the finger vein reader 201 may transmit data representative of the scanned finger vein pattern and the UIN to the one or more servers 108 via the network 107. In some implementations, the data is transmitted as a data packet. The data packet comprises a one or more frames having a plurality of subframes. For example, the frame may include a header subframe and a payload subframe. The header subframe may contain the UIN and the payload subframe may include the finger vein pattern data (e.g., the scanned finger vein pattern).

Additionally, in some implementations, the data sent to the servers (e.g., from the finger vein reader 201) may be time stamped. The time stamp may provide an additional layer of fraud protection. For example, the time stamp of the transmitted data from the finger vein reader may be compared to a particular time stamp applied by the one or more servers 108 or a timer maintained by the one or more servers 108 when the data is received. If the elapsed time (e.g., as measured by the difference or delta between two timestamps) exceeds a threshold, the data may be discarded (i.e., not considered) and/or flagged. As a specific example, the threshold could be approximately three seconds so that transactions associated with a timestamp delta greater than three seconds are denied while transactions associated with a timestamp delta less than three seconds may be approved (assuming the finger vein data and UIN also authorizes a transaction).

In operation 34, the one or more servers 108 receive the data from the finger vein reader 201 and authenticate the user. Specifically, the one or more servers 108 extracts the UIN and finger vein pattern from the received data. The matching module 111 of the one or more servers 108 compares the received UIN to stored UINs corresponding to profiles in the database 112. The matching module 111 selects one or more stored profiles with UINs that match the received UIN. The matching module 111 then compares the received finger vein pattern with stored finger vein patterns from the one or more selected profiles. The matching module 111 selects a stored profile (of the one or more selected profiles) having a stored finger vein pattern that matches the received finger vein pattern.

Said another way, the matching module 111 filters (i.e., removes from consideration) stored profiles with UINs that do not match the received UIN. The matching module 111 then compares the received finger vein pattern with one or more stored finger vein patterns from one or more remaining profiles in the database 112. That is, the matching module compares the received finger vein pattern to each finger vein pattern corresponding to each of the one or more remaining profiles. Thus, the user's identity is authenticated by verifying the received UIN and the received finger vein pattern from the user matches the stored UIN and stored finger vein pattern corresponding to the user's profile. In other words, the one or more servers 108 verify that the selected profile belongs to the user in response to the matching module 111 matching the received finger vein pattern to the stored finger vein pattern associated with the selected profile.

Once the one or more servers 108 authenticate the user, the one or more servers 108 may authorize a transaction. For example, the one or more servers 108 can authorize a payment from a financial account corresponding to the authenticated user/customer's profile (e.g., e-wallet 115) to a merchant's financial account. Additionally or alternatively, the one or more servers may authorize access to an area, room, building, terminal, network, document and/or allow a customer to complete banking transactions (e.g., online and/or via ATMs), etc., to which the user's profile indicates the user has access authority. For example, the finger vein reader 201 may be communicatively coupled to and capable of unlocking a door/gate lock, a terminal, or a computer in response to the user being authenticated by the one or more servers 108.

Still referring to FIG. 3, to be clear, the finger vein reader device 201 included in FIG. 3 is merely an example and the techniques presented herein need not utilize a finger vein reader device 201 for an in-person transaction. Additionally or alternatively, the techniques presented herein can facilitate online transactions, ATM transactions, access to a particular location (e.g., a building), etc. In these use cases, device 201, a portable scanner, and/or any device capable of capturing a finger vein pattern can execute at least a portion of the techniques presented herein. For example, a portable scanner may include hardware and software to allow direct communications with the one or more servers 108 and/or may communicate with another electronic device (e.g., via BLUETOOTH, USB, Wifi, NFC), which may act as an intermediary. Regardless, once a device connected to the system presented herein receives finger vein data, the device can execute instructions stored in computer readable memory to complete, or at least attempt to complete at least a portion of a transaction based on UIN and finger vein data (and potentially a time stamp too).

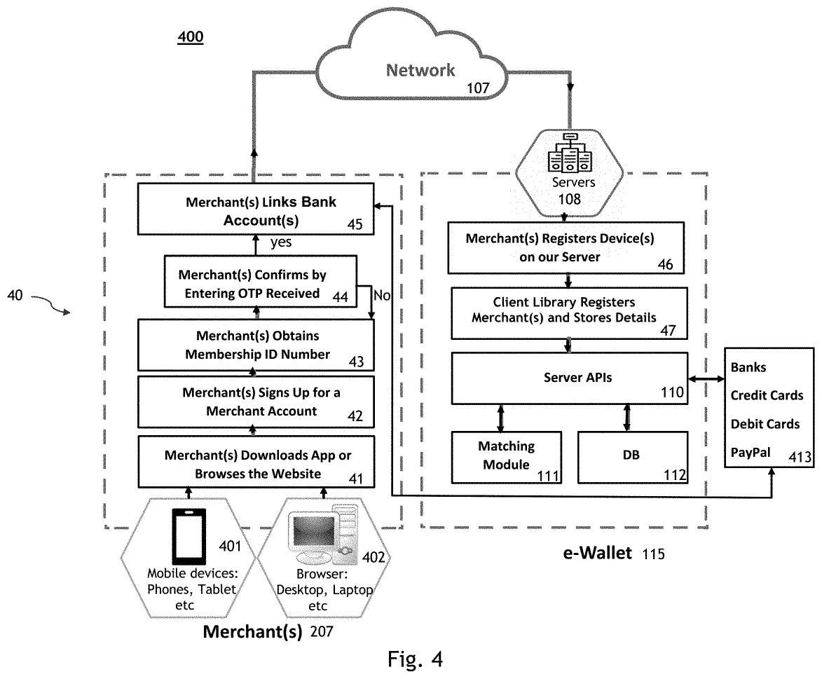

FIG. 4 illustrates the one-time merchant registration process 40 on an online platform 400 by using the downloadable App on a mobile device 401 or browser on a mobile device 401 or desktop or laptop 402. This registration process 40 allows the merchant to set up an account that will be used for the collections of revenue from transaction with customers when paying for services or goods. The account is also used in adding devices (e.g., finger vein reader 201) to the account, as desired.

The one-time merchant registration process 40 includes downloading an App or accessing a website via a merchant device 207 (e.g., the mobile device 401 or the computer 402) in operation 41, requesting an account in operation 42, receiving a merchant identification (ID) number in operation 43, confirming the merchant's identity with a one-time password (OTP) in operation 44, and linking third party service providers 413 (e.g., financial institution account, bank account, credit card account, PayPal, etc.) in operation 45. The one or more servers 108 receive the account information from the merchant device 207 and store it in a merchant account/profile in the database 112 to complete the registration process in operation 46.

In operation 42, the merchant requests an account via the App or web browser accessed in operation 41. For example, the App or web browser causes the merchant device 207 (e.g., mobile device 401 and/or computer 402) to communicate with the one or more servers 108 via the network 107, and request initiation of a merchant account registration with merchant's data (e.g., merchant's name, date of birth, business name, business address, phone number, etc.). The merchant may input the data via a graphical user interface of the merchant device 207.

In operation 43, the one or more servers 108 generate a membership ID number associated with the received merchant data. The membership ID number is transmitted from the one or more servers 108 to the merchant device 207 and is displayed to the merchant. In some implementations, the one or more servers 108 may further transmit instructions to the merchant device 207 to prompt the merchant to link the merchant account with a third party service provider 413. At operation 44, a merchant can confirm their identity with an OTP. Additionally or alternatively, merchant finger vein data (e.g., of a person authorized to act on behalf of the merchant) could be used to confirm the merchant identity at operation 44 (e.g., based on similar steps to operations 31-34).

In operation 45, the merchant links one or more accounts from third party service providers 413 to the merchant account. The service providers 413 may include one or more of a bank, a credit card company, PayPal, and/or other financial institutions. For example, the merchant may enter third party account information and/or login credentials for the one or more third party service provides 413 into the merchant device 207, which transmits the information to the one or more servers 108.

In operation 46, the one or more servers 108 store the merchant's data in a database 112. The one or more servers 108 receive the merchant's data and third-party account information, and generate a merchant profile/account comprising the merchant's data, membership ID number, and third party account information. The merchant profile is stored in the database 112 and indexed by the corresponding membership ID number. Once the merchant profile is stored in the database 112, the account registration is complete and the merchant can conduct transactions with users/customers who have a user account stored in the database 112. For example, the merchant may scan a user's finger vein pattern to register the patterns with the user's profile (however, this might also be possible prior to completing merchant registration process 40). Additionally, the merchant may scan a user's finger vein pattern for authorization of payment for a transaction from the user's account to the merchant's account.

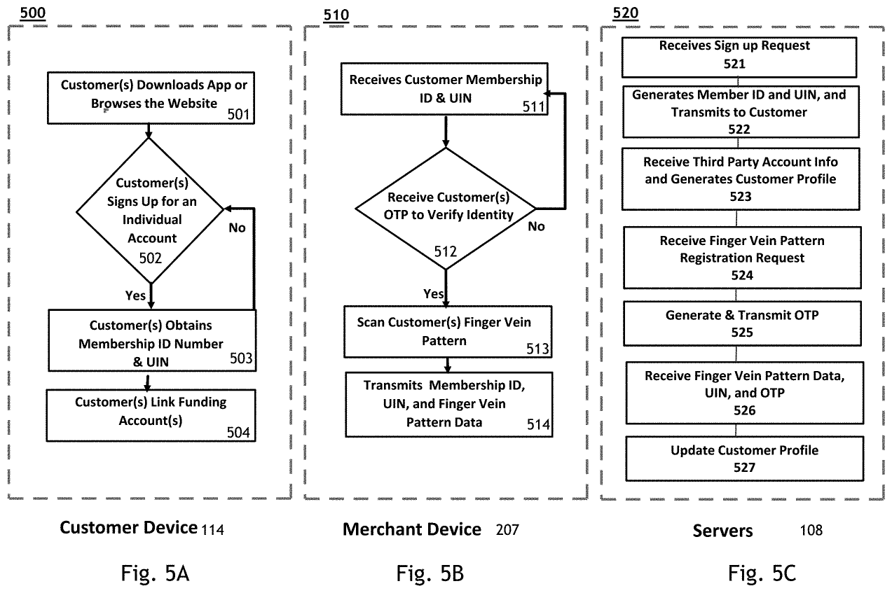

FIGS. 5A-5C are flow charts of processes that illustrate the one-time customer registration process, including the online sign up for a customer account and the one-time finger vein pattern registration, as detailed above with reference to FIGS. 1 and 2. Specifically, FIG. 5A illustrates a registration process 500 occurring at the user device 114, FIG. 5B illustrates a registration process 510 occurring at the merchant device 207, and FIG. 5C illustrates the registration process 520 occurring at the one or more servers 108.

Referring to FIG. 5A, the customer registration process 500 includes downloading an App or browsing a website in operation 501, receiving a sign up request from a in operation 502, receiving a customer membership ID number and a UIN in operation 503, and receiving customer funding accounts and transmitting the funding accounts to the one or more servers 108 in operation 504.

For example, at 502, the customer can enter personal information in the downloaded App or web browser on the customer device 114 to request the customer account. The customer device 114 can then transmit the information to the one or more servers for generating the customer's account. In operation 503, the user device 114 receives and displays a membership ID number and UIN associated with the customer's information (in accordance with the details provided above). The customer device 114 may further prompt the customer to link a funding account to the customer profile/account and receive funding account information. In response, the user may input funding account information into the customer device 114. The customer device 114 can then transmit the funding account information with the membership ID number and UIN to the one or more servers 108. The customer device 114 may receive a confirmation from the one or more servers 108 that the customer account registration is complete.

Now referring to FIG. 5B, a registration process 510 for registering a customer's finger vein pattern at a merchant device 207 includes receiving a customer membership ID number and UIN in operation 511, receiving and verifying a customer OTP in operation 512, scanning one or more finger vein patterns of a customer in operation 513, and transmitting the membership ID number, UIN and the finger vein pattern data to the one or more servers 108. Details of these operations are discussed above.

Referring to FIG. 5C, a registration process 520 for registering a customer's account and finger vein pattern data at one or more servers 108. The registration process 520 includes receiving a sign up or registration request in operation 521, generating and transmitting a membership ID number and UIN in operation 522, and receiving third party account information and generating a customer profile in operation 523. The customer profile includes the customer's account information, membership ID number, UIN, and third party account information.

In operation 525, the one or more servers 108 generate an OTP in response to receiving a request to register a finger vein pattern, a membership ID number, and a UIN. The generated OTP is transmitted to the customer device 114 corresponding to the membership ID number and UIN. For example, the OTP may be transmitted to a mobile device 101 or an email address associated with the membership ID number. In operation 526, the one or more servers receive finger vein pattern data containing one or more finger vein patterns, the customer's membership ID number, UIN, and OTP. The one or more servers 108 verify that the received OTP, membership ID number, and UIN match the transmitted OTP associated with the stored membership ID number and UIN. If the OTPs match, the one or more servers 108 update the customer profile corresponding to the received membership ID number and UIN with the received finger vein pattern data in operation 527. The updated customer profile is saved in database 112 for future authentication of the customer. If the OTPs do not match, an error message may be transmitted and/or the process 520 may restart.

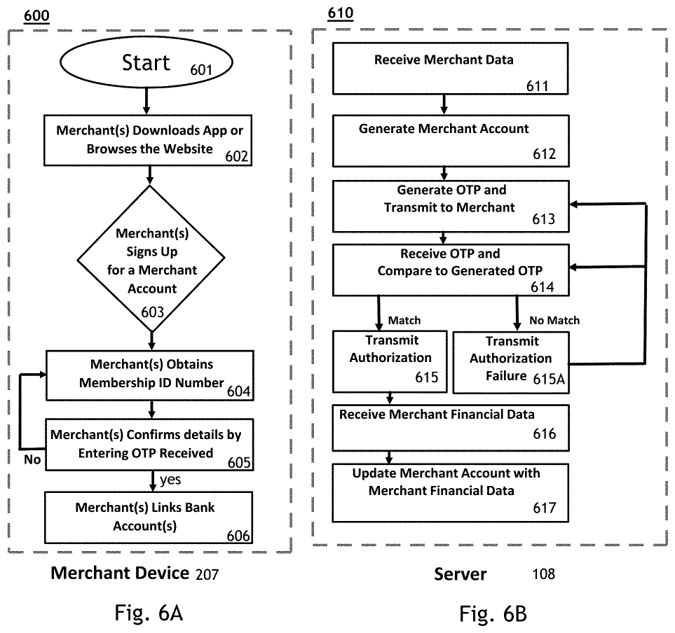

FIGS. 6A and 6B are flow charts of processes that illustrate the one-time merchant registration process, including the online sign up for a merchant account and adding of devices to the account, as detailed above with reference to FIG. 4. FIG. 6A illustrates a merchant registration process 600 occurring at the merchant device 207 and FIG. 6B illustrates the merchant registration process 610 occurring at the one or more servers 108.

Referring to FIG. 6A, the merchant device 207 is started in operation 601; the merchant device downloads an App or accesses a website in operation 602. In operation 603, the merchant signs up for a merchant account (as detailed above). The merchant device receives merchant data (e.g., business name, merchant first and last name, email address, business address, phone number, etc.) from the merchant. The merchant device transmits the received merchant information to the one or more servers 108. In operation 604, the merchant device receives a membership ID number from the one or more servers 108 and displays the membership ID number to the merchant.

In operation 605, the merchant device 207 receives an OTP inputted by the merchant. The merchant may have received the OTP via email or a message to a mobile device 401 associated with the merchant. The merchant device 207 transmits the OTP and membership ID number to the one or more servers 108 for authorization. The merchant device 207 receives a merchant confirms authorization if the one or more servers 108 transmits a confirmation that the OTP and the membership ID number match. If the OTP and the membership ID number do not match, the merchant device 207 receives and displays an error message to the merchant. The merchant device 207 may prompt the merchant to reenter the OTP and/or start the process 600 over. In operation 606, in response to authorization of the merchant, the merchant device 207 prompts the merchant to link a bank account or other financial institution account. The merchant device 207 receives the financial account information from the merchant and transmits it to the one or more servers 108. Once the merchant's bank account is linked to the merchant account, the process 600 is complete.

Now referring to FIG. 6B, at the one or more servers 108, the merchant registration process 610 includes receiving merchant data (e.g., business name, merchant first and last name, email address, business address, phone number, etc.) in operation 611 and, in response, generating a merchant account in operation 612. In operation 613, the one or more servers 108 generate an OTP associated with the generated merchant account and transmit the OTP to the merchant (e.g., via email, mobile device 401, or merchant device 207). In operation 614, the one or more servers 108 receive an OTP from the merchant device 207 and compare the received OTP to the generated OTP. If the OTPs match, the one or more servers 108 transmit an authorization message to the merchant device 207 in operation 615. If the OTPs do not match, an authentication failure message is transmitted to the merchant device 207 and the process may return to operation 613 or operation 614. In operation 616, the one or more servers 108 receive merchant financial data in response to authenticating the merchant, and update the merchant account with the financial data in operation 617. The merchant registration process 610 concludes after operation 617.

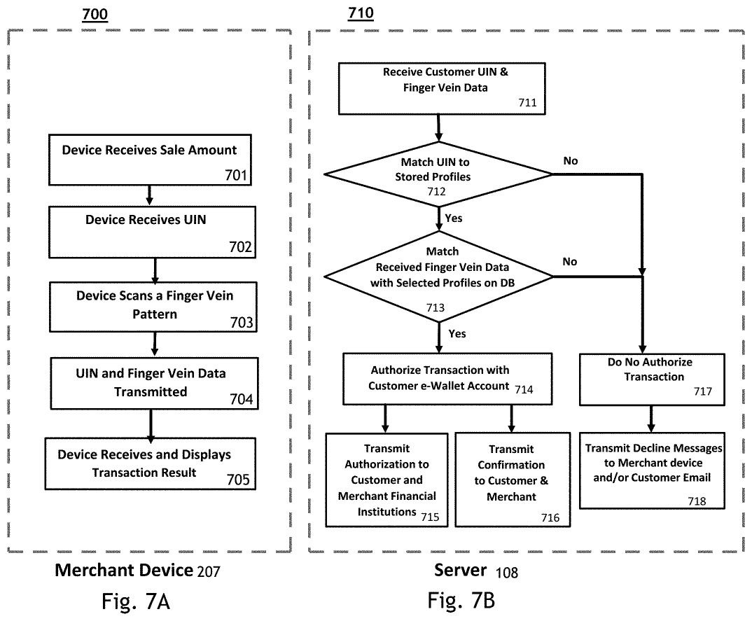

FIGS. 7A and 7B illustrate a complete transaction process from when a merchant inputs the cost of the service or goods (e.g., via barcode scanning) to when the customer and/or merchant input the Unique Identification Number (UIN) and the customer scans a registered finger (as detailed above with reference to FIG. 3). The device will then send the UIN and scanned finger vein data to the server for matching possibilities before authorization. FIG. 7A illustrates a transaction process 700 occurring at the merchant device 207, and FIG. 7B illustrates an authentication of a transaction process 710 occurring at one or more servers 108.

Now referring to FIG. 7A, in operation 701, the merchant device 207 receives a sale amount for a transaction and, in operation 702, the merchant device 207 receives a UIN. For example, the customer may enter the UIN into the merchant device 207. In operation 703, the merchant device 207 prompts the customer to place their finger on a finger vein pattern reader and scans the customer's finger vein pattern. In operation 704, the merchant device 207 transmits the UIN and finger vein pattern data to the one or more servers 108. As mentioned above, this transmission may also include a time stamp. In operation 708, the merchant device 207 receives and displays the transaction result. For example, the merchant device 207 may receive confirmation that the transaction has been authorized and completed. Alternatively, the merchant device 207 may receive a notice that the transaction has been declined. In some implementations, the process may restart at operation 702 if the transaction is declined. The transaction process 700 concludes after operation 705.

Now referring to FIG. 7B, the transaction process 710 includes receiving a customer UIN, finger vein pattern data, and a transaction sale amount at one or more servers 108. In operation 712, the one or more servers 108 match the received UIN to one or more stored profiles. For example, the matching module 111 of the one or more servers 108 compares the received UIN to the database 112 containing user/customer profiles, and selects one or more customer profile with associated UINs that matches the received UIN. In operation 713, the one or more servers compare the received finger vein pattern data with one or more finger vein patterns stored in the selected one or more profiles. For example, the matching module 111 of the one or more servers 108 compares the received finger vein pattern data (e.g., a scanned image of a finger vein pattern) with finger vein patterns stored in the one or more selected profiles until a match is found.

In response to finding a profile with a stored finger vein pattern matching the received finger vein pattern, the one or more servers 108 authorize a transaction on a customer account corresponding to the matched profile in operation 714. Thus, the one or more servers 108 authenticate the customer based on the received UIN and finger vein pattern. In operation 715, the one or more servers 108 transmit an authorization to the customer's financial institution and/or the merchant's financial institution for transfer of funds. Additionally, in operation 716, the one or more servers 108 transmit a confirmation to the customer and merchant. After operation 716, the authorization process 710 is completed.

Alternatively, at operation 712 and/or operation 713, if a matching UIN or finger vein pattern is not matched or found in the database 112, the one or more servers 108 denies the transaction in operation 717. That is, the customer's identity is not authenticated and the transaction is not authorized. In operation 718 the one or more servers transmits a decline message to the merchant and/or the customer.

Notably, at 713, the finger vein data received from 704 (e.g., scanned at the merchant POS device) need only be matched against finger vein data associated with the particular UIN. The UIN is not necessarily unique to the customer, but limits the amount of data that will be compared to the received finger vein data, thereby drastically reducing the amount of backend processing required to complete a transaction. Put another way, the particular manner in which the techniques presented herein combine UINs and finger vein data drastically improves the speed of biometric transactions while securing and authenticating transactions. Further, the techniques presented herein may be used with verifying and authenticating a user for access to a secured location, as noted above.

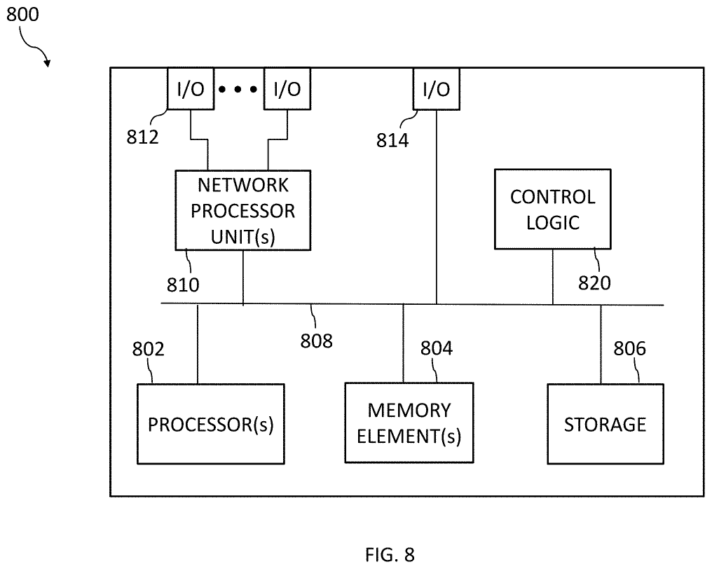

Referring to FIG. 8, FIG. 8 illustrates a hardware block diagram of a computing device 800 that may perform functions associated with operations discussed herein in connection with the techniques depicted in FIGS. 1-7B. In various embodiments, a computing device, such as computing device 800 or any combination of computing devices 800, may be configured as any entity/entities as discussed for the techniques depicted in connection with FIGS. 1-7B in order to perform operations of the various techniques discussed herein.

In at least one embodiment, the computing device 800 may include one or more processor(s) 802, one or more memory element(s) 804, storage 806, a bus 808, one or more network processor unit(s) 810 interconnected with one or more network input/output (I/O) interface(s) 812, one or more I/O interface(s) 814, and control logic 820. In various embodiments, instructions associated with logic for computing device 800 can overlap in any manner and are not limited to the specific allocation of instructions and/or operations described herein.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with memory element(s) 804 (or vice versa), or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 810 may enable communication between computing device 800 and other systems, entities, etc., via network I/O interface(s) 812 (wired and/or wireless) to facilitate operations discussed for various embodiments described herein. In various embodiments, network processor unit(s) 810 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 812 can be configured as one or more Bluetooth, USB port(s), NFC port(s) Ethernet port(s), Fibre Channel ports, any other I/O port(s), and/or antenna(s)/antenna array(s) now known or hereafter developed. Thus, the network processor unit(s) 810 and/or network I/O interface(s) 812 may include suitable interfaces for receiving, transmitting, and/or otherwise communicating data and/or information in a network environment.

I/O interface(s) 814 allow for input and output of data and/or information with other entities that may be connected to computer device 800. For example, I/O interface(s) 814 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 820 can include instructions that, when executed, cause processor(s) 802 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 820) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, cloud computing network, any other appropriate architecture and/or system that facilitates communications in a network environment, and/or any suitable combination thereof.

Networks through which communications propagate can use any suitable technologies for communications including wireless communications (e.g., 2G/3G/4G/5G/nG, CDMA, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, ‘exemplary embodiment’ and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

What is claimed is:

1. A method of authenticating a user comprising:
receiving, at a processor, a unique identification number (UIN) and finger vein data corresponding to a user;
comparing, via the processor, the received UIN to a database comprising stored user profiles, the user profiles comprising stored UINs with corresponding stored finger vein data;
identifying, via the processor, one or more user profiles based on the UIN;
comparing, via the processor, the received finger vein data to the stored finger vein data of the identified one or more user profiles; and
authenticating the user based on the comparing.

2. The method of claim 1, wherein authenticating the user comprises determining a match based on comparing the received finger vein data with the stored finger vein data of the identified one or more user profiles.

3. The method of claim 2, wherein authenticating the user further comprises authorizing a transaction from an account of the user.

4. The method of claim 1, wherein authenticating the user comprises not authorizing a transaction from an account of the user in response to determining no matches based on comparing the received UIN to stored user profiles and/or comparing the received finger vein data with the stored finger vein data of the identified one or more user profiles.

5. The method of claim 1, wherein identifying the one or more user profiles comprises filtering user profiles, of the one or more user profiles, that do not correspond to the received UIN.

6. The method of claim 1, wherein the UIN comprises an alphanumeric string of characters.

7. The method of claim 6, wherein the alphanumeric string of characters comprises at least five characters.

8. The method of claim 1, wherein the stored finger vein data comprises finger vein profiles of one or more fingers of the user.

9. The method of claim 1, wherein received finger vein data comprises a finger vein profile of the user.

10. A system for authenticating a user comprising:
a database comprising one or more user profiles corresponding a unique identification number (“UIN”) and finger vein data of one or more users;
a transceiver configured to receive authentication data, the authentication data comprising a UIN and finger vein data of the user;
a processor configured to:
compare a received UIN to UINs stored in the database;
identify one or more user profiles stored in the database based on the UIN comparison;
compare received finger vein data to finger vein data corresponding to the one or more user profiles; and
authenticate the user based on the finger vein data comparison.

11. The system of claim 10, wherein the processor is further configured to determine a match based on comparing the received finger vein data with the finger vein data of the database.

12. The system of claim 11, wherein the processor is further configured to authorize a transaction from an account of a user corresponding to the received authentication data.

13. The system of claim 10, wherein the processor is further configured to:
determine the received authentication data does not match profile data stored in the database,
wherein authenticating the user comprises not authorizing a transaction from an account of the user.

14. The system of claim 13, wherein determining the received authentication data does not match profile data stored in the database comprises:
determining the received UIN does not match a UINs stored in the database, and/or the received finger vein data does not match stored finger vein data corresponding to the identified one or more user profiles.

15. The system of claim 10, wherein received finger vein data comprises a finger vein profile of the user.

16. A non-transitory computer-readable storage medium storing instructions that, when executed by a processor, cause the processor to perform:
receiving a unique identification number (“UIN”) and finger vein data corresponding to a user;
comparing the received UIN to a database comprising stored user profiles, the user profiles comprising stored UINs with corresponding stored finger vein data;
identifying one or more user profiles based on the UIN;
comparing the received finger vein data to the stored finger vein data of the identified one or more user profiles; and
authenticating the user based on the comparing.

17. The non-transitory computer-readable storage medium storing instructions of claim 16, wherein authenticating the user comprises instructions for determining a match based on comparing the received finger vein data with the stored finger vein data of the identified one or more user profiles.

18. The non-transitory computer-readable storage medium storing instructions of claim 16, wherein authenticating the user further comprises instructions for authorizing a transaction from an account of the user.

19. The non-transitory computer-readable storage medium storing instructions of claim 16, wherein authenticating the user comprises instructions for not authorizing a transaction from an account of the user in response to determining no matches based on comparing the received UIN to stored user profiles and/or comparing the received finger vein data with the stored finger vein data of the identified one or more user profiles.

20. The non-transitory computer-readable storage medium storing instructions of claim 16, wherein identifying one or more user profiles comprises instructions for filtering profiles, of the one or more user profiles, that do not correspond to the received UIN.
